(19) United States
(12) Patent Application Publication
(10) Pub. No.: US 2009/0056294 A1
(43) Pub. Date: Mar. 5, 2009

(54) Dual storage dust collector

(76) Inventor: Clinton J. McCutchen, Sand Springs, OK (US)

Correspondence Address: Frank J. Catalano;Gable Gotwals, 10th Floor, 100 W. 5th Street, Tulsa, OK, 74103, US

(21) Appl. No.: 12/288,515

(22) Filed: Oct. 21, 2008

Related U.S. Application Data
(63) Continuation of application No. 11/655,505, filed on Jan. 19, 2007.

(51) Int. Cl. B01D 46/48; A47L 9/00

(52) U.S. Cl. 55/432

(57) ABSTRACT

A dual storage dust collector for a vacuum cleaner has a hopper for receiving the dust from the vacuum and a dump tank for receiving the dust from the hopper. A valve between the hopper and the dump tank is operable whether or not the vacuum is running. Thus, whenever the valve is open, dust falls from the hopper into the dump tank and, whenever the valve is closed, the dump tank can be disconnected from the hopper and emptied without interruption of the vacuuming process.

### BACKGROUND OF THE INVENTION

This invention relates generally to vacuum cleaning systems and more particularly concerns dual storage dust collectors used with many such systems.

Presently, an upper hopper and lower dump tank or disposable bag are separated by a flapper or gate pivoting on an offset axis with a weight below one side of the axis. The hopper and tank or bag taken together form a single sealed container with the flapper between the tanks. While the hopper and the tank or bag are connected, they are at equalized pressure and the weight tends to hold the flapper closed so that collected dust settles on the closed flapper. When the collected dust overcomes the weight, the flapper drops to deposit settled dust into the dump tank or bag. When sufficient dust has fallen to allow the weight to regain domination of the balance of the system, the flapper closes until the dust again overcomes the weight. Thus, the flapper is continuously bobbing during the operation of the vacuum.

The flapper assembly does not pneumatically seal the hopper from the tank or bag. Consequently, as long as the hopper and the tank or bag remain properly sealed at their connection point, the pressure in the hopper and the tank or bag remains equalized and dust settled on the flapper falls by gravity into the tank or bag. In tank-type collectors, the tank must be removed in order to empty the tank. In bag-type collectors, the disposable bag must be removed from the assembly and tied to seal the bag and a new disposable bag mounted on the assembly. But if the tank or bag were removed while the vacuum was operating, the vacuum would at least momentarily and probably continuously draw additional ambient air through the opening where the tank or bag had been connected to the hopper and through the unsealed portions of the flapper assembly. This would stir up and circulate dust from the tank or bag into the air, returning some of the dust to the cleaned environment. It would also reduce the vacuum power of the unit because of the increase in total area through which ambient air is admitted to the system. Therefore, these vacuum systems are always shut down before the dump tank or bag is removed and remain out of service until the dump tank or a new bag is reconnected. In dust intensive applications, such as in floor grinding and wall sanding operations, the dump tank or bag must be frequently emptied, perhaps multiple times per hour, especially in trades in which workers have contractually established maximum weight-carry limitations. The down time for workers and vacuum equipment while tanks are emptied or bags are replaced can be a considerable proportion of a work day.

It is, therefore, an object of this invention to provide a vacuum cleaner dust collector that can be emptied or replaced while the vacuum is operating. Another object of this invention is to provide a vacuum cleaner dust collector that controls the use of its dust disposal operation independently of the operation of the vacuum cleaner. A further object of this invention is to provide a vacuum cleaner dust collector that is less likely to re-circulate collected dust to the atmosphere during emptying than known dust collectors. It is also an object of this invention to provide a vacuum cleaner dust collector that can be divided into pneumatically separate compartments.

### SUMMARY OF THE INVENTION

In accordance with the invention a dust collector for a vacuum is provided which has a hopper for receiving the dust from the vacuum and a dump tank for receiving the dust from the hopper. A valve is connected in a pneumatically discrete path between the hopper and the dump tank. The valve is operable between a first position in which the pneumatically discrete path is opened and a second position in which the pneumatically discrete path is closed. In the opened condition, the hopper and the dump tank are at equalized pressure and dust in the hopper falls by force of gravity into the dump tank. In the closed condition, the hopper and the dump tank are pneumatically separated and the dump tank can be removed from the hopper, emptied, and reconnected to the hopper. The valve is operated, preferably manually, externally of the dust collector and independently of the operating status of the vacuum. The valve is not responsive to the operating status of the vacuum. Therefore, the dust in the hopper can be deposited into the dump tank and the dump tank can be emptied without interrupting the operation of the vacuum cleaner.

### BRIEF DESCRIPTION OF THE DRAWINGS

Other objects and advantages of the invention will become apparent upon reading the following detailed description and upon reference to the drawings in which:

FIG. 1 is a front elevation view of a vacuum cleaner with a dual storage dust collector;

FIG. 2 is a perspective assembly view of the hopper and valve of the dust collector of the vacuum cleaner of FIG. 1;

FIG. 3 is a top plan view of the hopper and valve of the dust collector of the vacuum cleaner of FIG. 1;

FIG. 4 is a side elevation view of the hopper and valve of the dust collector of the vacuum cleaner of FIG. 1;

FIG. 5 is a front elevation of the hopper and valve of the dust collector of the vacuum cleaner of FIG. 1;

FIG. 6 is a cross-sectional view taken along the line 6-6 of FIG. 5; and

FIG. 7 is a cross-sectional view taken along the line 7-7 of FIG. 1.

While the invention will be described in connection with a preferred embodiment thereof, it will be understood that it is not intended to limit the invention to that embodiment or to the details of the construction or arrangement of parts illustrated in the accompanying drawings.

### DETAILED DESCRIPTION

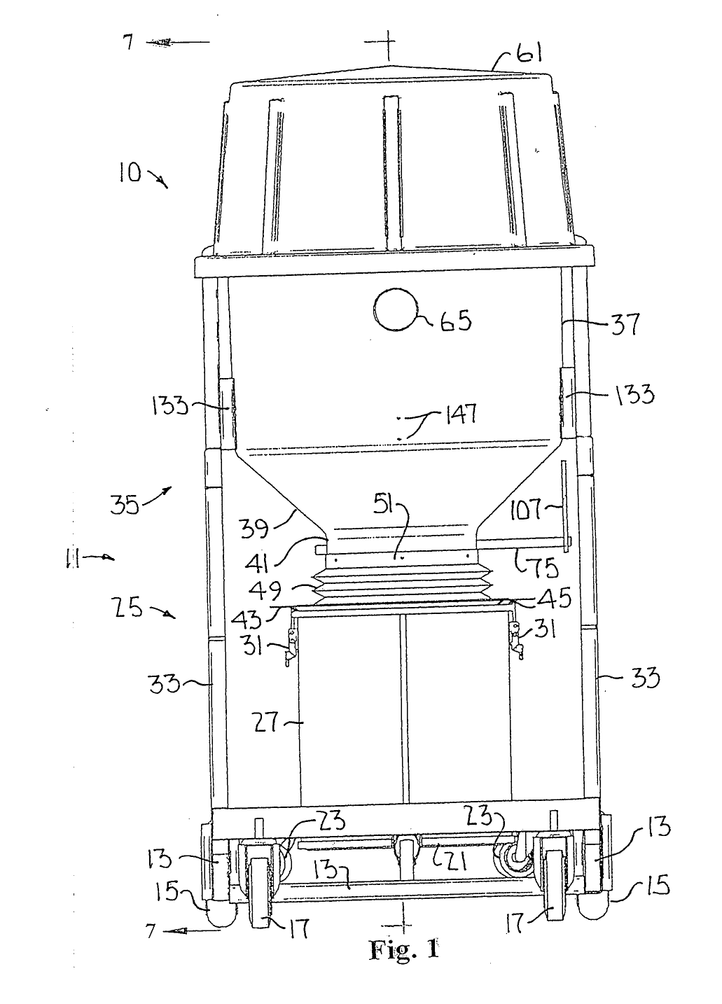

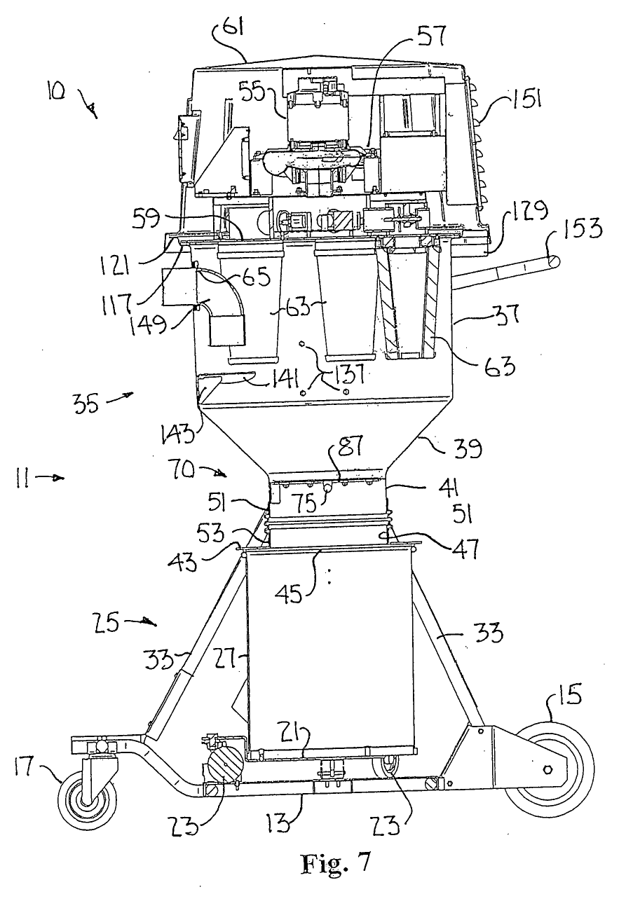

Turning first to FIGS. 1 and 7, a vacuum cleaner 10 is illustrated which incorporates a dual storage dust collector 11. The vacuum cleaner 10 has a chassis 13 with a pair of rear wheels 15 for moving the vacuum cleaner 10 to and from areas to be vacuumed and two casters 17 which allow the vacuum cleaner 10 to roll and change direction during vacuuming.

A platform 21 which rolls on four casters 23 onto and from the chassis 13 of the vacuum cleaner 10 supports the lower portion 25 of the dust collector 11. The lower portion 25 of the dust collector 11, as shown, includes a cylindrical dump tank 27 with an open top 29 and a pair of diametrically opposed cam-over clamps 31.

A frame 33 extending upwardly from the chassis 13 supports the upper portion 35 of the dust collector 11. The upper portion 35 of the dust collector 11 includes a barrel 37, a hopper 39 and a neck 41. The barrel 37 extends downwardly to the hopper 39 which in turn extends downwardly to the neck 41.

To detachably connect the upper and lower portions 35 and 25 of the dust collector 11 into a single, pneumatically discrete container, a cover plate 43 sized to overlap the upper rim 45 of the dump tank 27 has an upwardly extending annular flange 47. The upper end of a flex connector 49 is mounted by a first clamp 51 to the lower end of the hopper neck 41 and the lower end of the flex connector 49 is mounted by a second clamp 53 to the dump tank cover plate flange 47. When the dump tank platform 21 is rolled onto the vacuum cleaner chassis 13 and the hopper neck 41 and dump tank cover plate flange 47 are aligned, the flex connector 49 can be extended to seat the cover plate 43 on the dump tank rim 45. The cam-over clamps 31 can then be snapped closed to seal the plate 43 against the tank rim 45.

The powered operating components of the vacuum cleaner 10, including the motor 55 and valves 57, are mounted on a plate 59 seated on top of the barrel 37 and protected by a cover 61. The vacuum filters 63 are suspended below the plate 59 in the barrel 37. The vacuum intake 65 extends through the upper front wall of the barrel 37.

The hopper 39 receives the dust collected in the barrel 37 by the vacuum cleaner 10 and the dump tank 27 receives the dust from the hopper 39. To permit separation of the dump tank 27 from the hopper 39, an isolation valve 70 is connected in a pneumatically discrete path between the hopper 39 and the dump tank 27. The valve 70 is operable between a first position in which the pneumatically discrete path is opened and a second position in which the pneumatically discrete path is closed. In the opened condition, the hopper 39 and the dump tank 27 are at equalized pressure and dust in the hopper 39 falls by force of gravity into the dump tank 27. In the closed condition, the hopper 39 and the dump tank 27 are pneumatically separated and the dump tank 27 can be removed from the hopper 39, emptied, and reconnected to the hopper 39. The valve 70 is operated, preferably manually, externally of the dust collector 11 and independently of the operating status of the vacuum cleaner 10. The valve 70 is not responsive to the operating status of the vacuum cleaner 10. Therefore, the dust in the hopper 39 can be deposited into the dump tank 27 and the dump tank 27 can be emptied without interrupting the operation of the vacuum cleaner 10.

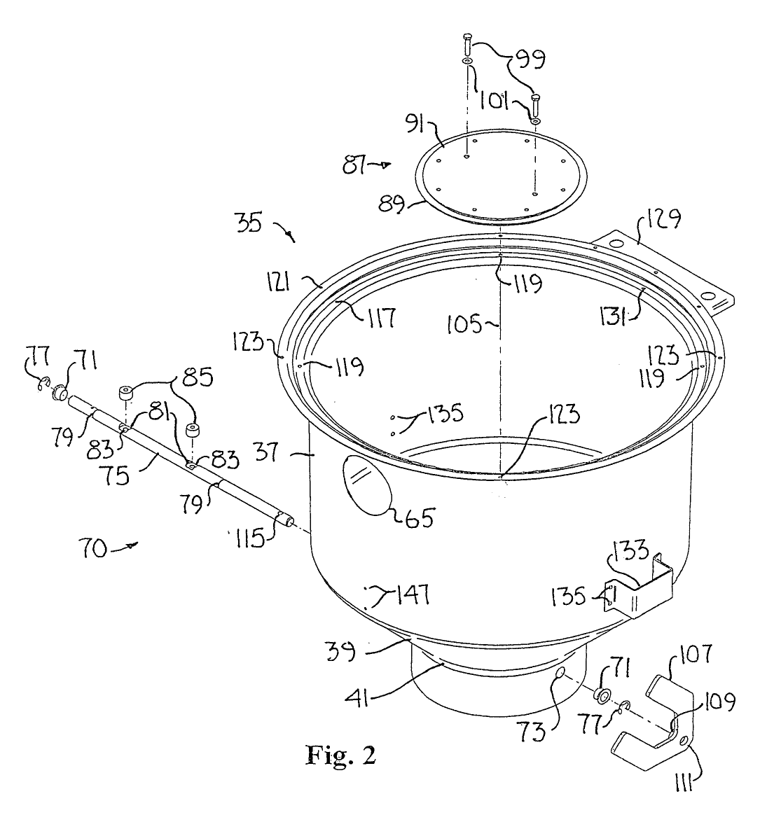

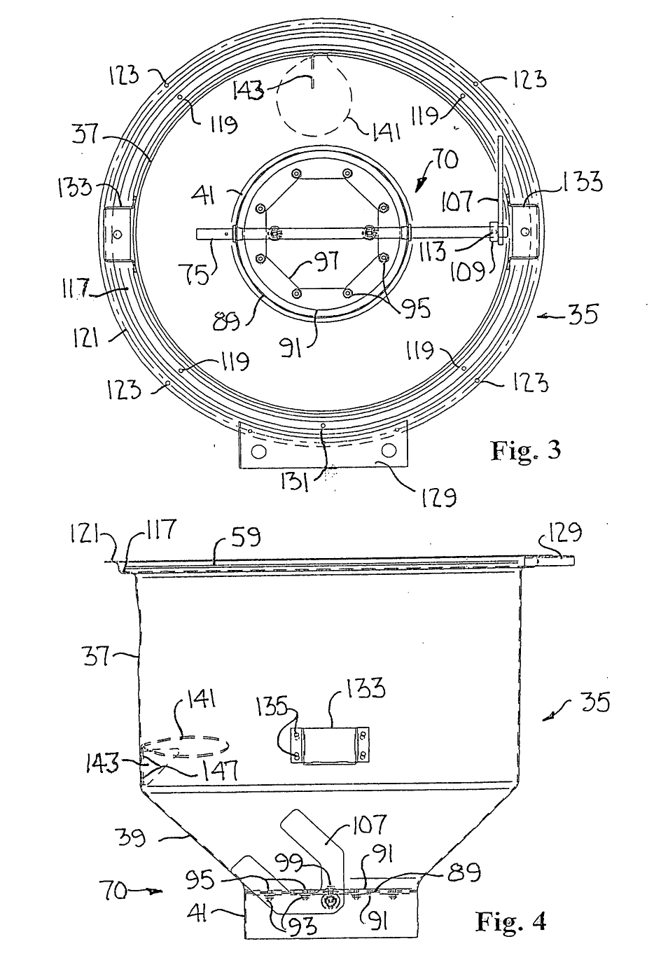

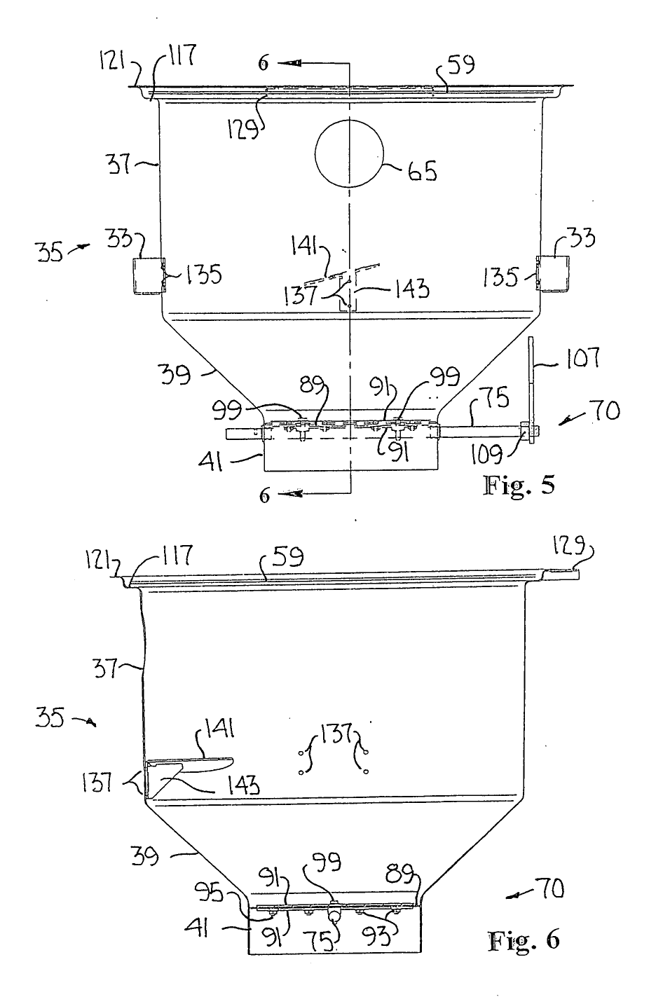

As seen in FIGS. 2-6, the isolation valve 70 is mounted in the neck 41 of the hopper 39. A pair of bushings 71 are disposed in diametrically opposed openings 73 in the upper portion of the neck 41. A shaft 75 extending through the bushings 71 is secured in the neck 41 by snap rings 77 engaged in grooves 79 on the circumference of shaft extensions outside of the neck 41. The shaft 75 a pair of co-planar spaced apart flats 81 with threaded holes 83 centered on the flats 81 and extending through the shaft 75. As shown, the flats 81 are equally displaced from the center of the neck 41 when the shaft 75 is mounted in the bushings 71. Each flat 81 seats a cylindrical stand-off 85. The end faces of the stand-offs 85 are co-planar. A circular valve plate 87 is formed by sandwiching a concentrically larger polyurethane seal 89 between a pair of metal discs 91 and securing the laminar arrangement together with nuts 93 and bolts 95. A positive-lock wire 97 may be serially engaged from bolt 95 to bolt 95 to assure that the bolts 95 cannot rotate to loosen the laminar layers of the plate 87. The valve plate 87 is seated on the stand-offs 85 and fastened to the valve shaft 75 using bolts 99 and washers 101. The diameter of the metal layers 91 of the plate 87 are small enough to permit rotation of the plate 87 and shaft 75 in the neck 41 and the diameter of the polyurethane layer 89 is great enough to pneumatically seal the valve plate 87 along the inner wall of the neck 41 when the valve plate 87 is rotated to a plane perpendicular to the center axis 105 of the neck 41. One end of the shaft 75 is extended outwardly to a valve handle 107. As shown, the valve handle 107 is a yoke shaped member with a sleeve 109 at its apex 111 for receiving the shaft 75. A set screw 113 extends radially through the sleeve 109 to a another flat 115 in the valve shaft 75 to lock the handle 107 to the shaft 75. The valve plate 87 is manually rotatable for 90 degrees between horizontal and vertical orientations, the horizontal orientation being the sealed perpendicular or closed position above described and the vertical orientation being a fully opened position in which the plate 87 is parallel to the center axis 105 of the neck 41.

As best seen in FIG. 2, the top of the barrel 37 of the upper portion 35 of the dust collector 11 has an annular seat 117 with apertures 119 and an outer annular flange 121 with apertures 123. The vacuum cleaner mounting plate 59, seen in FIG. 7, can be fastened in the seat 117 by screws (not shown) with a closed cell foam gasket 125 between the seat 117 and the plate 59 to pneumatically seal the barrel 37 to plate 59 connection. The vacuum cleaner cover 61 can be secured to the barrel 37 by screws (not shown) into the aperture 123 in the barrel flange 121. Preferably, the barrel 37, hopper 39 and neck 41 are of unitary construction so that no seals are required in the upper portion components. The bushings 71 in the neck 41 are made of brass, sealing the mounting holes 73 for the shaft 75. A closed cell foam gasket 127 is also sandwiched between the dump tank rim 45 and the dump tank cover plate 43 to pneumatically seal this connection. Thus, when the valve 70 is in the opened condition, the pressure in the upper and lower components 35 and 25 of the dust collector 11 is substantially equalized and dust collected in the hopper 39 will fall under the force of gravity into the dump tank 27. When the valve 70 is in the closed condition, the pneumatically discrete path between the hopper 39 and the dump tank 27 is also pneumatically sealed, so that the dump tank 27 can be disconnected from the hopper 39 without turning off the vacuum cleaner 10, without any significant loss of vacuum power and without releasing any significant amount of collected dust into the atmosphere.

To complete the vacuum cleaner 10, a flange 129 diametrically opposite the vacuum intake 65 is radially extended outwardly from the barrel 37 below the barrel flange 121 and the cover 61 is contoured to be aligned on the radial flange 129. A locating key 131 on the barrel seat 117 engages in a dimple (not shown) on the bottom of the vacuum cleaner mounting plate 59. When the cover 61 is aligned on the radial flange 129 and the plate 59 is aligned on the locating key 131, the exhaust system of the vacuum cleaner 10 is properly aligned. Diametrically opposed brackets 133 fixed to the exterior of the barrel 37 by screws 135 through holes 137 in the barrel 37 facilitate mounting the upper portion 35 of the dust collector 11 on the frame 33. As best seen in FIG. 7, an angled baffle, preferably of unitary construction with a bracket 143, is mounted inside the barrel 37 directly below the vacuum intake 65 by use of screws 147 through holes 145 in the barrel 37. An elbow 149 at the vacuum intake 65 directs incoming air and dust at the baffle 141, so that a vortex of air flow occurs in the barrel 37 above the baffle 141 and turbulence in the lower part of the barrel 37 and the hopper 39, if any, is reduced. The vacuum cleaner exhaust passes through vents 151 in the cover 65. A handle 151 mounted on the barrel 37 below the radial flange 129 facilitates tipping the vacuum cleaner 10 on its rear wheels 15 to move the unit from location to location. The vacuum cleaner 10 has been described in reference to a small, portable, commercial model approximately 2′ wide by 4′ deep by 5′ high. However, the principles of dual storage herein disclosed may also be applied to permanent industrial vacuums many stories in height.

Thus, it is apparent that there has been provided, in accordance with the invention, a vacuum cleaner with dual storage dust collector that fully satisfies the objects, aims and advantages set forth above. While the invention has been described in conjunction with a specific embodiment thereof, it is evident that many alternatives, modifications and variations will be apparent to those skilled in the art and in light of the foregoing description. Accordingly, it is intended to embrace all such alternatives, modifications and variations as fall within the spirit of the appended claims.

What is claimed is:

1. For use with a vacuum cleaner, a dust collector comprising:
a hopper for receiving the dust from the vacuum;
a dump tank for receiving the dust from said hopper; and
a valve connected in a pneumatically discrete path between said hopper and said dump tank, said valve being operable between a first position in which said pneumatically discrete path is opened and a second position in which said pneumatically discrete path is closed.

2. A dust collector according to claim 1 further comprising means external to the dust collector for operating said valve.

3. A dust collector according to claim 1, said valve being operable independently of an operating status of the vacuum.

4. A dust collector according to claim 1, said valve being non-responsive to an operating status of the vacuum.
